(19) United States
(12) Patent Application Publication
(10) Pub. No.: US 2026/0056440 A1
(43) Pub. Date: Feb. 26, 2026

(54) OPTICAL PATH CONTROL MEMBER AND DISPLAY DEVICE INCLUDING SAME

(71) Applicant: LG INNOTEK CO., LTD., Seoul (KR)

(72) Inventors: In Hae LEE, Seoul (KR); Byung Sook KIM, Seoul (KR); Gyu Lin LEE, Seoul (KR); Chan Mi JU, Seoul (KR)

(21) Appl. No.: 19/102,731

(22) PCT Filed: Jul. 28, 2023
(86) PCT No.: PCT/KR2023/011085

§ 371 Date: Feb. 10, 2025

(30) Foreign Application Priority Data
Aug. 10, 2022 (KR) 10-2022-0099824
Aug. 10, 2022 (KR) 10-2022-0099826
Aug. 10, 2022 (KR) 10-2022-0099827

(51) Int. Cl. G02F 1/1676

(52) U.S. Cl. CPC G02F 1/1676

(57) ABSTRACT

An optical path control member according to an embodiment includes a first substrate; a first electrode disposed on the first substrate; a second substrate disposed on the first substrate; a second electrode disposed under the second substrate; and a light conversion part disposed between the first electrode and the second electrode, wherein the light conversion part includes an accommodation part and a partition wall part which are disposed alternately, wherein a light conversion material is disposed inside the accommodation part, and the light conversion material includes a dispersion liquid and light conversion particles dispersed in the dispersion liquid, wherein the partition wall part has a first width defined as a long width of the partition wall part and a second width defined as a short width of the partition wall part, wherein the accommodation part has a third width defined as a long width of the accommodation part and a fourth width defined as a short width of the accommodation part, and wherein the third width is greater than the second width.

### TECHNICAL FIELD

An embodiment relates to an optical path control member and a display device including the same.

### BACKGROUND ART

An optical path control member is a light-blocking film that changes a path and transmittance of light emitted from a light source. The optical path control member is attached to a front of a display panel and used. The optical path control member adjusts an angle of light emission. By this, an user can use the display panel for privacy purposes.

The optical path control member is used on a window of a vehicle or a building. By this, some external light is partially blocked to prevent glare. Alternatively, an inside can be made invisible from an outside.

The optical path control member includes a light conversion part. The light conversion part includes an accommodation part and a partition wall part. A light conversion material is disposed inside the accommodation part. The light conversion material includes light conversion particles. The light conversion particles are dispersed or aggregated by an application of voltage. By this, the light conversion part can be converted into a light transmitting part or a light blocking part.

That is, the light transmittance of the accommodation part changes. In addition, the light transmits through the partition wall part. Therefore, the optical path control member changes the light transmittance according to sizes of the accommodation part and the partition wall part.

### Disclosure

### Technical Problem

An embodiment provides an optical path control member with improved light conversion characteristics.

### Technical Solution

An optical path control member according to an embodiment a first substrate; a first electrode disposed on the first substrate; a second substrate disposed on the first substrate; a second electrode disposed under the second substrate; and a light conversion part disposed between the first electrode and the second electrode, wherein the light conversion part includes an accommodation part and a partition wall part which are disposed alternately, wherein a light conversion material is disposed inside the accommodation part, and the light conversion material includes a dispersion liquid and light conversion particles dispersed in the dispersion liquid, wherein the partition wall part has a first width defined as a long width of the partition wall part and a second width defined as a short width of the partition wall part, wherein the accommodation part has a third width defined as a long width of the accommodation part and a fourth width defined as a short width of the accommodation part, and wherein the third width is greater than the second width.

### Advantageous Effects

The optical path control member according to the embodiment includes a partition wall part and an accommodation part. Sizes of the partition wall part and the accommodation part are formed at a set ratio.

Accordingly, when the optical path control member is driven in a privacy mode, light-blocking characteristic of the optical path control member can be improved. For example, a short width of the partition wall part is formed small. Accordingly, an amount of light transmitted through the partition wall part is reduced. Accordingly, the light-blocking characteristic of the optical path control member can be improved in the privacy mode.

In addition, when the optical path control member is driven in a public mode, transmission characteristic of the optical path control member can be improved. For example, a long width of the partition wall part is formed large, and a short width of the accommodation part is formed small. Accordingly, an amount of light transmitted through the partition wall part and the accommodation part is increased. Accordingly, the light transmission characteristic of the optical path control member can be improved in the public mode.

### DESCRIPTION OF DRAWINGS

FIG. 1 is a perspective view of an optical path control member according to a first embodiment.

FIGS. 2 to 4 are cross-sectional views taken along A-A′ section of FIG. 1.

FIG. 5 is a drawing for explaining a mode of an optical path control member according to an embodiment.

FIGS. 6 to 8 are drawings for explaining various shapes of a light conversion part of an optical path control member according to a first embodiment.

FIG. 9 is a perspective view of an optical path control member according to a second embodiment.

FIG. 10 is a drawing for explaining an arrangement of an electrode, an accommodation part, and a partition wall part of an optical path control member according to a second embodiment.

FIGS. 11 and 12 are cross-sectional views taken along A-A′ section of FIG. 9.

FIGS. 13 and 14 are cross-sectional views taken along B-B′ section of FIGS. 9 and 10.

FIG. 15 is a drawing for explaining light transmission according to a mode of an optical path control member according to a second embodiment.

FIGS. 16 and 17 are cross-sectional views of another embodiment taken along A-A′ section of FIGS. 9 and 10.

FIG. 18 is another drawing for explaining light transmission according to modes of an optical path control member according to a second embodiment.

FIG. 19 is another drawing for explaining an arrangement of an electrode, an accommodation part, and a partition wall part of an optical path control member according to a second embodiment.

FIGS. 20 and 21 are cross-sectional views taken along C-C′ section of FIG. 19.

FIGS. 22 and 23 are cross-sectional views taken along D-D′ section of FIG. 19.

FIG. 24 is another drawing for explaining light transmission according to modes of an optical path control member according to a second embodiment.

FIG. 25 is another perspective view of an optical path control member according to a second embodiment.

FIG. 26 is another perspective view of an optical path control member according to a second embodiment.

FIG. 27 is another drawing for explaining an arrangement of an electrode, an accommodation part, and a partition wall part of an optical path control member according to a second embodiment.

FIGS. 28 to 30 are cross-sectional views taken along A-A′ section of FIG. 26.

FIG. 31 is another drawing for explaining an arrangement of an electrode, an accommodation part, and a partition wall part of an optical path control member according to a second embodiment.

FIGS. 32 to 34 are cross-sectional views taken along F-F′ section of FIG. 33.

FIG. 35 is a perspective view of an optical path control member according to a third embodiment.

FIGS. 36 and 37 are cross-sectional views taken along A-A′ section of FIG. 35.

FIG. 38 is a drawing for explaining a mode of an optical path control member according to an embodiment.

FIGS. 39 to 46 are various enlarged views of region B of FIG. 36.

FIG. 47 is a top view of an optical path control member according to an embodiment.

FIG. 48 is a cross-sectional view taken along C-C′ section of FIG. 47.

FIGS. 49 to 53 are drawings for explaining an embodiment of a display device to which an optical path control member according to an embodiment is applied.

### MODE FOR INVENTION

Hereinafter, embodiments of the present disclosure will be described in detail with reference to the accompanying drawings. However, the spirit and scope of the present disclosure is not limited to a part of the embodiments described, and may be implemented in various other forms, and within the spirit and scope of the present disclosure, one or more of the elements of the embodiments may be selectively combined and redisposed.

In addition, unless expressly otherwise defined and described, the terms used in the embodiments of the present disclosure (including technical and scientific terms) may be construed the same meaning as commonly understood by one of ordinary skill in the art to which the present disclosure belongs, and the terms such as those defined in commonly used dictionaries may be interpreted as having a meaning that is consistent with their meaning in the context of the relevant art.

In addition, the terms used in the embodiments of the present disclosure are for describing the embodiments and are not intended to limit the present disclosure. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present disclosure, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “contacted” to another element, it may include not only when the element is directly “connected” to, “coupled” to, or “contacted” to other elements, but also when the element is “connected”, “coupled”, or “contacted” by another element between the element and other elements.

In addition, when described as being formed or disposed “on (over)” or “under (below)” of each element, the “on (over)” or “under (below)” may include not only when two elements are directly connected to each other, but also when one or more other elements are formed or disposed between two elements.

Further, when expressed as “on (over)” or “under (below)”, it may include not only the upper direction but also the lower direction based on one element.

Hereinafter, an optical path control member according to the first embodiment will be described with reference to the drawings.

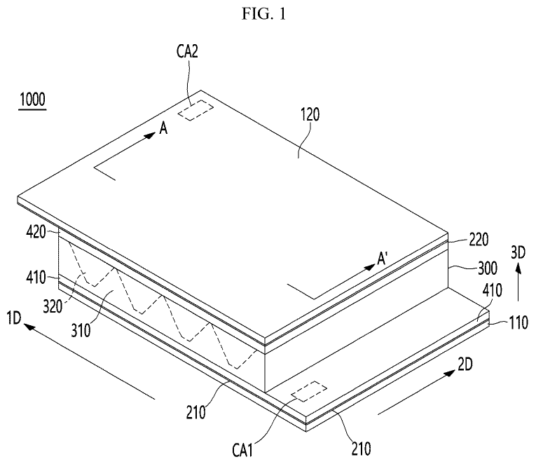

Referring to FIGS. 1 to 5, the optical path control member 1000 includes a first substrate 110, a second substrate 120, a first electrode 210, a second electrode 220, and a light conversion part 300.

The first substrate 110 supports the first electrode 210. In addition, the second substrate 120 supports the second electrode 220. The first substrate 110 and the second substrate 120 may be rigid or flexible.

In addition, at least one substrate among the first substrate 110 and the second substrate 120 is transparent. For example, at least one substrate among the first substrate 110 and the second substrate 120 may include a transparent substrate capable of transmitting light.

At least one of the first substrate 110 and the second substrate 120 may include glass, plastic, or a flexible polymer film. For example, the flexible polymer film may include polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, or polystyrene (PS). However, the embodiment is not limited thereto.

In addition, at least one of the first substrate 110 and the second substrate 120 may be a flexible substrate having flexible characteristics.

In addition, at least one of the first substrate 110 and the second substrate 120 may be a curved or bent substrate. Accordingly, the optical path control member may also have flexible, curved or bent characteristics. Accordingly, the optical path control member may have various designs.

The first substrate 110 and the second substrate 120 extend in a first direction 1D, a second direction 2D, and a third direction 3D.

The first direction 1D may be a length direction of the substrate 110 and 120. The second direction 2D may be a width direction of the substrate 110 and 120. The third direction 3D may be a thickness direction of the substrate 110 and 120.

The first substrate 110 and the second substrate 120 have a thickness within a set range. For example, the first substrate 110 and the second substrate 120 may each have a thickness of 25 μm to 150 μm.

The first electrode 210 is disposed on one surface of the first substrate 110. In detail, the first electrode 210 is disposed on an upper surface of the first substrate 110. That is, the first electrode 210 is disposed between the first substrate 110 and the second substrate 120.

In addition, the second electrode 220 is disposed on one surface of the second substrate 120. In detail, the second electrode 220 is disposed on a lower surface of the second substrate 120. That is, the second electrode 220 is disposed between the first substrate 110 and the second substrate 120. In addition, the second electrode 220 faces the first electrode 210.

At least one of the first electrode 210 and the second electrode 220 includes a transparent conductive material. For example, at least one of the first electrode 210 and the second electrode 220 may include a conductive material having a light transmittance of 80% or more. For example, at least one of the first electrode 210 and the second electrode 220 may include indium tin oxide, indium zinc oxide, copper oxide, tin oxide, zinc oxide, or titanium oxide.

The first electrode 210 and the second electrode 220 may each have a thickness of 10 nm to 300 nm.

Alternatively, at least one of the first electrode 210 and the second electrode 220 may include various metals to have low resistance. For example, at least one of the first electrode 210 and the second electrode 220 may include chromium (Cr), nickel (Ni), copper (Cu), aluminum (Al), silver (Ag), molybdenum (Mo), gold (Au), titanium (Ti), or an alloy thereof.

At least one of the first electrode 210 and the second electrode 220 may have a mesh shape including an opening.

Accordingly, even if at least one of the first electrode 210 and the second electrode 220 includes a metal, the electrode is not visible from an outside. In addition, a light transmittance can be increased by the openings. Therefore, the optical path control member can have improved visibility and brightness.

The first electrode 210 and the second electrode 220 can be disposed on an entire surface of one surface of the first substrate 110 and the second substrate 120, respectively. In detail, the first electrode 210 and the second electrode 220 can be surface electrodes disposed on one surface of the first substrate 110 and the second substrate 120, respectively.

Alternatively, the first electrode 210 and the second electrode 220 can be disposed as pattern electrodes on one surface of the first substrate 110 and the second substrate 120, respectively. That is, the first electrode 210 and the second electrode 220 may be a plurality of pattern electrodes disposed on one surface of the first substrate 110 and the second substrate 120, respectively.

The first substrate 110 and the second substrate 120 each include a protrusion. The first substrate 110 includes a first protrusion. The second substrate 120 includes a second protrusion. The first protrusion and the second protrusion include a connection region. The connection region is connected to a circuit board.

In detail, the first protrusion includes a first connection region CA1, and the second protrusion includes a second connection region CA2.

Upper surfaces of the first connection region CA1 and the second connection region CA2 expose a conductive material. For example, a first electrode 210 is exposed in the first connection region CA1, and a second electrode 220 is exposed in the second connection region CA2.

Thereby, the optical path control member is electrically connected to an external circuit board by the first connection region CA1 and the second connection region CA2.

The light conversion part 300 is disposed between the first substrate 110 and the second substrate 120. In detail, the light conversion part 300 is disposed between the first electrode 210 and the second electrode 220.

A buffer layer 410 is disposed between the first electrode 210 and the light conversion part 300. As a result, the adhesion between the first electrode 210 and the light conversion part 300 is improved.

An adhesive layer 420 is disposed between the first electrode 210 and the light conversion part 300. As a result, the second substrate 110 and the light conversion part 300 are bonded.

The light conversion part 300 includes a plurality of partition wall parts 310 and a plurality of accommodation parts 320. A light conversion material 330 is disposed inside the accommodation part 320. The light conversion material 330 includes a light conversion particle and a dispersion liquid. The light conversion particle moves by the application of voltage. The dispersion liquid disperses the light conversion particle. The optical path control member changes the light transmission characteristics by the light conversion particle. In detail, the optical path control member changes the light transmittance by an movement of the light conversion particle.

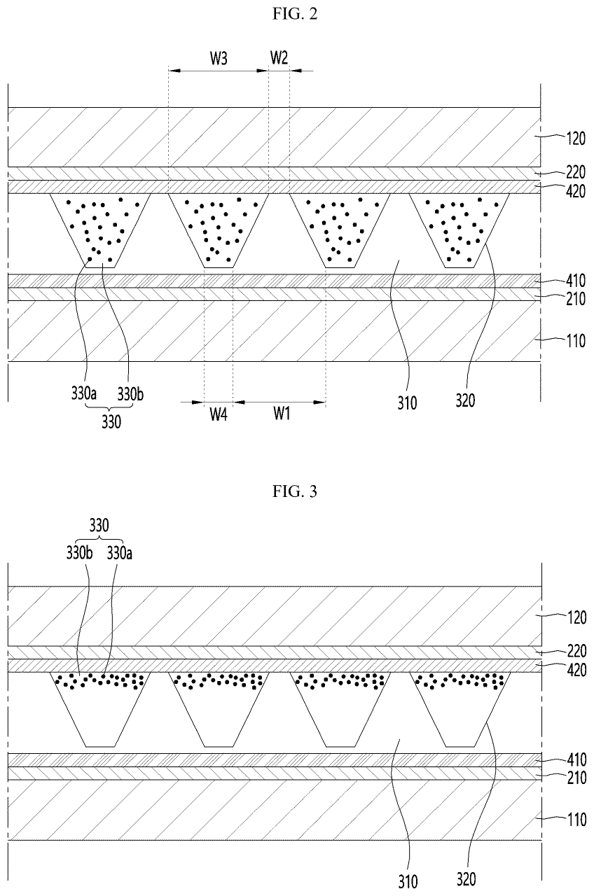

Referring to FIGS. 2 to 4, the partition wall part 310 separates the accommodation part into a plurality of accommodation parts. The partition wall part 310 includes a transparent material. The partition wall part 310 transmits light.

Widths of the partition wall part 310 and the accommodation part 320 are different. For example, the width of the accommodation part 320 is larger than the width of the partition wall part 320.

In addition, the width of the accommodation part 320 narrows as the accommodation part 320 extends from the second electrode 220 toward the first electrode 210.

The partition wall part 310 and the accommodation part 320 are alternately disposed. That is, one partition wall part 310 is disposed between adjacent accommodation parts 320. One accommodation part 320 is disposed between adjacent partition wall parts 310.

The partition wall part 310 may include a resin material. For example, the partition wall part 310 may include a photocurable resin material. For example, the partition wall part 310 may include a UV resin or a transparent photoresist resin. Alternatively, the partition wall part 310 may include a urethane resin or an acrylic resin, etc.

The accommodation part 320 is formed by partially removing the light conversion part 300. Accordingly, the accommodation part 320 is in contact with an adhesive layer 420. In addition, the accommodation part 320 is spaced apart from the buffer layer 410.

A light conversion material 330 is disposed inside the accommodation part 320. The light conversion material 330 includes a light conversion particle 330a and a dispersion liquid 330b.

The dispersion liquid 330b disperses the light conversion particle 330a. The dispersion liquid 330b includes a transparent material. The dispersion liquid 330b may include a nonpolar solvent. In addition, the dispersion liquid 330b may include a material capable of transmitting light. For example, the dispersion liquid 330b may include a halocarbon oil, a paraffin oil, or isopropyl alcohol.

The light conversion particles 330a are dispersed in the dispersion liquid 330b.

The light conversion particles 330a include a material capable of absorbing light. That is, the light conversion particles 330a are light absorbing particles. The light conversion particles 330a have a color. For example, the light conversion particles 330a may have a black color. For example, the light conversion particles 330a may include carbon black particles.

A surface of the light conversion particles 330a is charged. Accordingly, the light conversion particles 330a have polarity. For example, the surface of the light conversion particles 330a may be charged with a negative charge. Accordingly, the light conversion particles 330a move toward the first electrode 210 or the second electrode 220 by applying a voltage.

The light transmittance of the accommodation part 320 is changed by the light conversion particle 330a. Therefore, the accommodation part 320 is changed into a light blocking part or a light transmitting part. That is, the light transmittance of the accommodation part 330a is changed by dispersion and aggregation of the light conversion particle 330a.

For example, a mode of the optical path member is changed from a first mode to a second mode by an applied voltage. Alternatively, the mode of the optical path member is changed from the second mode to the first mode by the applied voltage.

The optical path control member becomes a light blocking part in the first mode. That is, the light transmittance of the optical path control member decreases. As a result, the optical path control member is driven in a privacy mode.

In addition, the optical path control member becomes a light transmitting part in the second mode. That is, the light transmittance of the optical path control member increases. As a result, the optical path control member is driven in a public mode.

Switching from the first mode to the second mode is implemented by the movement of the light conversion particle 330a. The surface of the light conversion particle 330a has a charge. The light conversion particle 330a can move toward the electrode to which a positive voltage is applied according to the characteristics of the charge.

When no voltage is applied as in FIG. 2, the light conversion particle 330a is uniformly dispersed in the dispersion liquid 330b. Accordingly, a region through which light can be transmitted becomes smaller. Accordingly, the light transmittance of the optical path control member decreases. Accordingly, the optical path control member is driven in the privacy mode as in (a) of FIG. 5.

In addition, when a voltage is applied as in FIG. 3, the light conversion particle 330a moves. For example, a negative (−) electrode is applied to the first electrode 210, and a positive (+) electrode is applied to the second electrode 220. In addition, the light conversion particle 330a has a negative charge. Therefore, the light conversion particle 330a moves toward the second electrode 220. Accordingly, the region through which light can be transmitted becomes smaller. Accordingly, the light transmittance of the optical path control member decreases. Accordingly, the optical path control member is driven in a privacy mode as shown in (a) of FIG. 5.

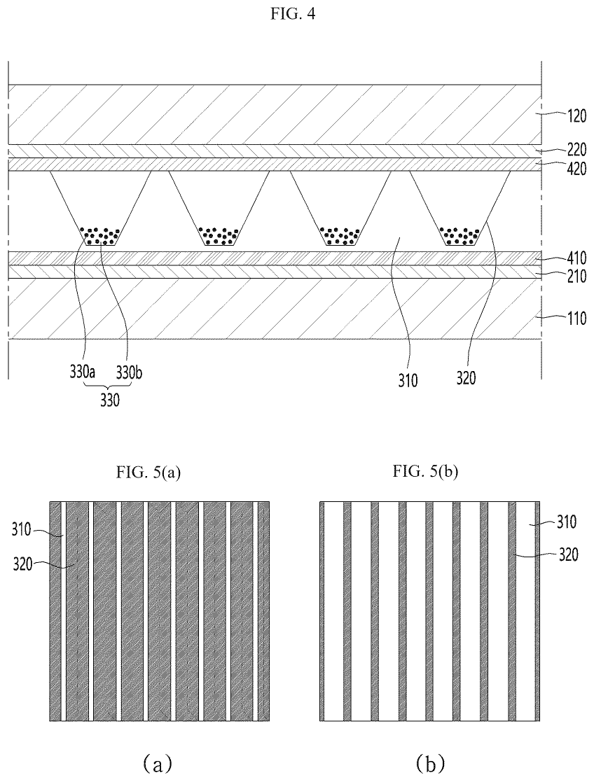

Alternatively, when an voltage is applied as in FIG. 4, the light conversion particle 330a moves. For example, a positive (+) electrode is applied to the first electrode 210, and a negative (−) electrode is applied to the second electrode 220. In addition, the light conversion particle 330a has a negative charge. Therefore, the light conversion particle 330a moves toward the first electrode 210. Accordingly, the region through which light can be transmitted increases. Accordingly, the light transmittance of the optical path control member increases. Accordingly, the optical path control member is driven in a public mode as in (b) of FIG. 5.

The optical path control member is driven in two modes depending on the user's surrounding environment. Therefore, the optical path control member can be used in various environments regardless of the user's environment.

The partition wall part 310 and the accommodation part 320 have a size of a set range.

The partition wall part 310 has a first width w1 and a second width w2. The first width w1 is a long width of the partition wall part 310. The second width w2 is a short width of the partition wall part 310. The first width w1 is a width a portion adjacent to the first electrode 210. The second width w2 is a width of a portion adjacent to the second electrode 220.

In addition, the accommodation part 320 has a third width w3 and a fourth width w4. The third width w3 is a long width of the accommodation part 320. The fourth width w4 is a short width of the accommodation part 320. The third width w3 is a width a portion adjacent to the second electrode 220. The fourth width w4 is a width of a portion adjacent to the first electrode 210.

The third width w3 is different from the second width w2. In detail, the third width w3 is larger than the second width w2. That is, the width of the accommodation part 320 adjacent to the second electrode 220 is larger than the width of the partition wall part 310 adjacent to the second electrode 220.

Accordingly, the light-blocking characteristic of the optical path control member can be improved in the privacy mode. That is, since the third width w3 is larger than the second width w2, a width of the light conversion particle 330a moving in a direction of the second electrode can be increased. Therefore, when light moves from the first substrate 110 to the second substrate 120, the light transmittance in the privacy mode is reduced.

In addition, the first width w1 and the second width w2 may have a ratio within a set range. In detail, a ratio (w1:w2) of the first width w1 and the second width w2 may be 9:1 or more.

Accordingly, the light-blocking characteristic in the privacy mode may be improved. That is, the second width w2 is formed very small. Therefore, the light transmitted through the second width w2 is reduced. Therefore, when light moves from the first substrate 110 toward the second substrate 120, the light transmittance in the privacy mode is reduced.

In addition, the transmission characteristic in the public mode may be improved. That is, the first width w1 is formed very large. Therefore, the light transmitted through the first width w1 is increased. Therefore, when light moves from the first substrate 110 toward the second substrate 120, the light transmittance of the public mode increases.

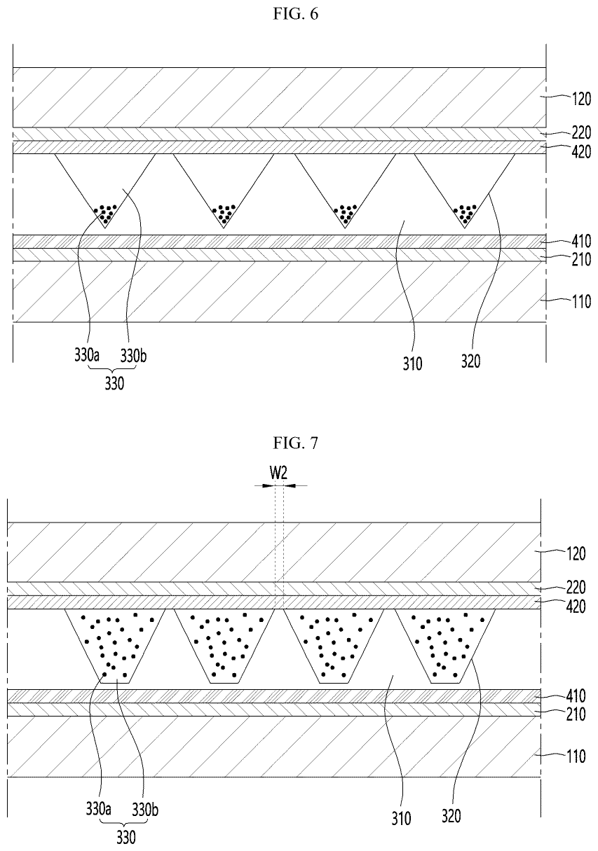

Hereinafter, various examples of the optical path control member according to the first embodiment will be described with reference to FIGS. 6 to 8.

Referring to FIG. 6, the width of the accommodation part 320 may be formed very small. In detail, the fourth width w4 may be close to 0. For example, the fourth width w4 may be 0. Alternatively, the fourth width w4 may be greater than 0 and less than or equal to 1 μm. In addition, the fourth width w4 may be smaller than the second width (w).

When the optical path control member is driven in the public mode, the light conversion particle 330a moves toward a short width of the accommodation part 320. Accordingly, when the short width of the accommodation part 320 increases, the region through which light is transmitted in the public mode decreases. Accordingly, the light transmittance of the optical path control member may decrease.

Accordingly, when the fourth width w4 is formed close to 0, the region through which light is transmitted in the public mode may increase. Accordingly, the fourth width w4 may be 0 to 1 μm or less. Accordingly, the light transmittance in the public mode may be improved.

Referring to FIG. 7, the short width of the partition wall part 310 may be formed very small. In detail, the second width w2 may be 1 μm to 2 μm.

When the optical path control member is driven in the privacy mode, light is transmitted through the short width of the partition wall part 310. Accordingly, when the short width of the partition wall part 310 increases, the region through which light is transmitted in the privacy mode increases. Accordingly, the light transmittance of the optical path control member can be increased.

Therefore, the second width w2 is formed in a set range. By this, the region through which light is transmitted in the privacy mode can be reduced. In detail, if the second width w2 exceeds 2 μm, the light-blocking characteristic in the privacy mode can be reduced. In addition, if the second width w2 of the partition wall part 310 is less than 1 μm, the adhesive characteristic of the light conversion part 300 and the adhesive layer 420 can be reduced. By this, the reliability of the optical path control member can be reduced.

Referring to FIG. 8, the adhesive layer 420 of the optical path control member can be omitted. Accordingly, the light conversion part 300 is in direct contact with the second electrode 220.

In detail, the first substrate 110 and the second substrate 120 can include a rigid material. For example, the first substrate 110 and the second substrate 120 may include glass.

Accordingly, the first substrate 110, the first electrode 210, the light conversion part 300, the second substrate 120, and the second electrode 220 may be bonded by sealing an outer edge region of the optical path control member. Alternatively, the first substrate 110, the first electrode 210, the light conversion part 300, the second substrate 120, and the second electrode 220 may be bonded by a bonding member that is bonded to an outer side of the optical path control member.

The first substrate 110 and the second substrate 120 include a rigid material. Therefore, when performing edge sealing or mechanical bonding, the first substrate 110 and the second substrate 120 may be prevented from being damaged.

Accordingly, the optical path control member can omit the adhesive layer, so a thickness of the optical path control member can be reduced.

The optical path control member according to the first embodiment includes a partition wall part and an accommodation part having a set size.

Accordingly, when the optical path control member is driven in a privacy mode, the light-blocking characteristic of the optical path control member can be improved. For example, the short width of the partition wall part is formed small. Accordingly, the amount of light transmitted through the partition wall part is reduced. Accordingly, the light-blocking characteristic of the optical path control member can be improved in the privacy mode.

In addition, when the optical path control member is driven in a public mode, the transmission characteristic of the optical path control member can be improved. For example, the long width of the partition wall part is formed large, and the short width of the accommodation part is formed small. Accordingly, the amount of light transmitted through the partition wall part and the accommodation part is increased. Accordingly, the light transmission characteristic of the optical path control member can be improved in the public mode.

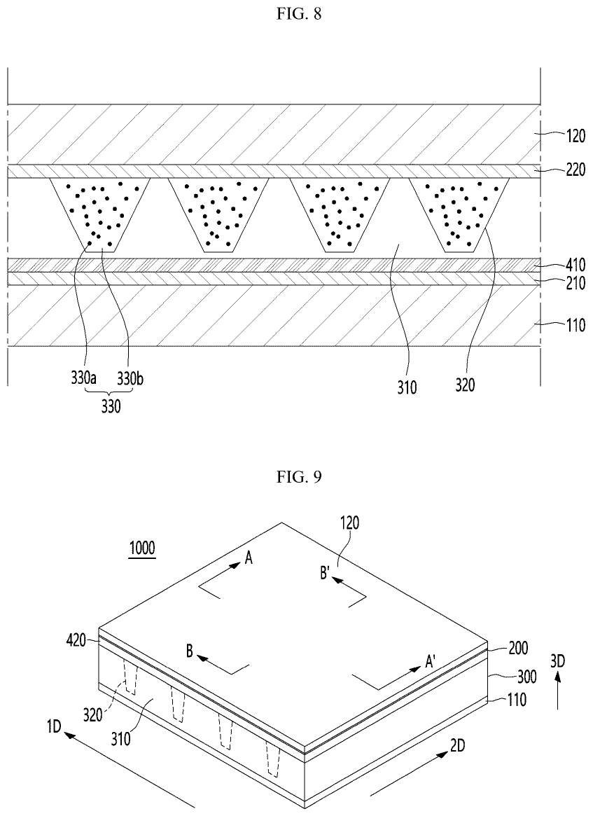

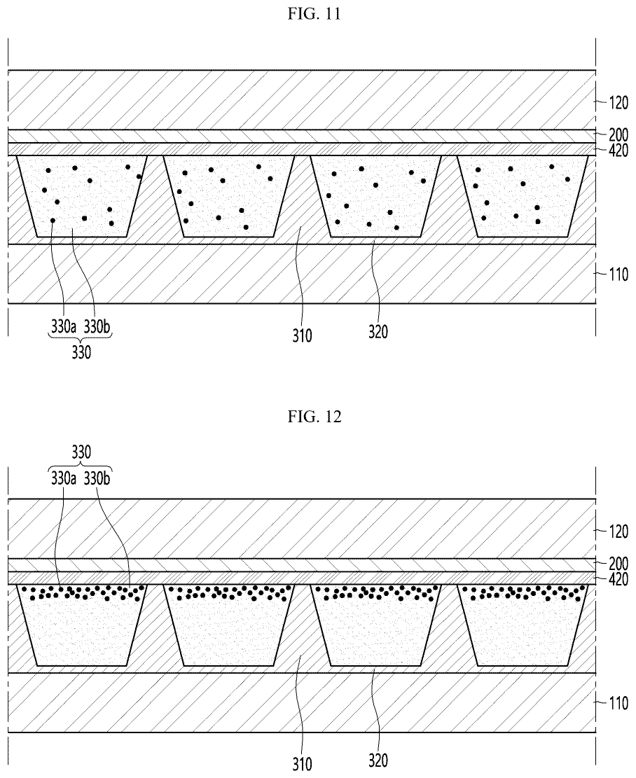

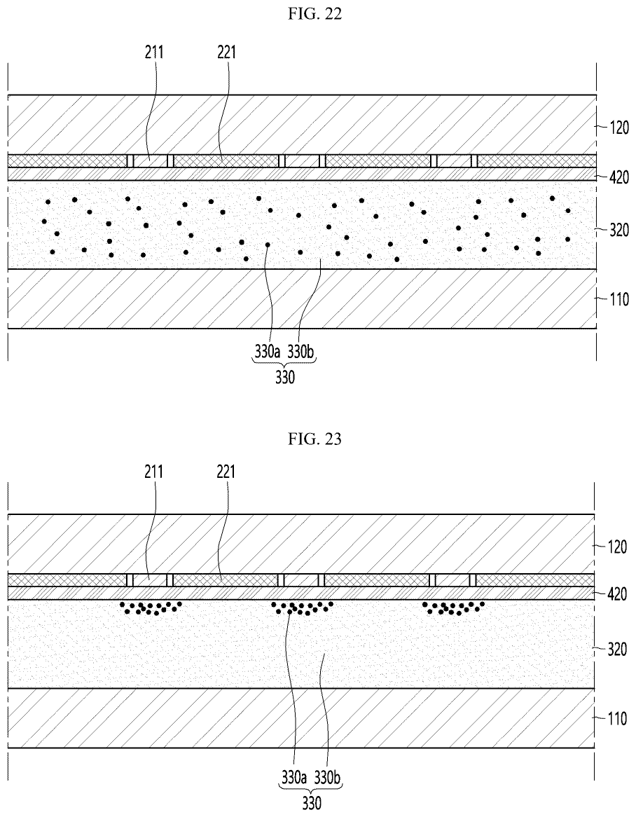

Hereinafter, the optical path control member according to a second embodiment will be described with reference to FIGS. 9 to 34. A same description as that of the first embodiment is omitted in a description of the second embodiment. Also, a same drawing reference numerals are given to a same configuration as the first embodiment. The first embodiment and the second embodiment may be combined. Alternatively, the first embodiment and the second embodiment may be independent.

Referring to FIGS. 9 to 12, the optical path control member 1000 according to the second embodiment includes a first substrate 110, a second substrate 120, a first electrode 210, a second electrode 220, and a light conversion part 300.

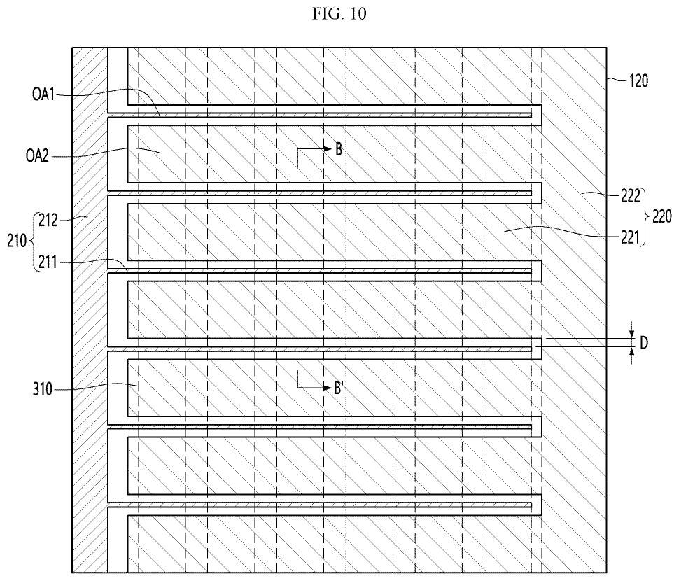

Referring to FIGS. 9 and 10, the first electrode 210 and the second electrode 220 may be disposed on one surface of the second substrate 120. In detail, the first electrode 210 and the second electrode 220 may be spaced apart from each other on one surface of the second substrate 120.

The first electrode 210 and the second electrode 220 are partially disposed on one surface of the second substrate 120.

The first electrode 210 includes a first electrode part 211 and a second electrode part 212. The first electrode part 211 extends in a first direction 1D. The first electrode part 211 extends in a different direction from the accommodation part 320. For example, the first electrode part 211 may extend in a direction perpendicular to a direction in which the accommodation part 320 extends.

The second electrode part 212 extends in a second direction 2D. The second electrode part 212 extends in a direction corresponding to the accommodation part 320. For example, the second electrode part 212 may extend in a direction parallel to the direction in which the accommodation part 320 extends.

The first electrode part 211 and the second electrode part 212 are connected to each other. For example, the first electrode part 211 and the second electrode part 212 are formed integrally.

The second electrode part 212 connects a plurality of first electrode parts 211. Accordingly, a plurality of first electrode parts 211 may be connected to a circuit board by the second electrode part 212.

The first electrode part 211 aggregates the light conversion particle 330a. For example, a positive voltage may be applied to the first electrode 210. The light conversion particle 330a may move toward the first electrode part 211 by attraction.

The first electrode 210 may be formed with an area within a set range. In detail, the first electrode 210 may be 20%, 10%, or 5% or less of an area of an effective region of the second substrate 120. The effective region is a region in which light transmittance changes by an application of voltage. If the first electrode 210 exceeds 20% of the area of the effective region of the second substrate 120, a size of the region in which the light conversion particle 330a is aggregated increases. Accordingly, the light transmittance of the optical path control member may decrease in the public mode.

In addition, the first electrode part 211 may be formed with a width within a set range. In detail, a width of the first electrode part 211 may be 10 μm to 100 μm, 20 μm to 90 μm, 30 μm to 80 μm, or 30 μm to 60 μm.

If the width of the first electrode part 211 is less than 10 μm, the conductivity of the first electrode part 211 decreases. Accordingly, the driving characteristics of the optical path control member may decrease. In addition, if the width of the first electrode part 211 exceeds 100 μm, a size of a region where the light conversion particle 330a is aggregated increases. Accordingly, the light transmittance of the optical path control member may decrease in the public mode.

The second electrode 220 includes a third electrode part 221 and a fourth electrode part 222. The third electrode part 221 extends in the first direction 1D. The third electrode part 221 extends in a different direction from the accommodation part 320. For example, the third electrode part 221 may extend in a direction perpendicular to a direction in which the accommodation part 320 extends. In addition, the third electrode part 221 can extend in a direction parallel to a direction in which the first electrode part 211 extends.

The fourth electrode part 222 extends in the second direction 2D. The fourth electrode part 222 extends in a direction corresponding to the accommodation part 320. For example, the fourth electrode part 222 can extend in a direction parallel to a direction in which the accommodation part 320 extends. In addition, the fourth electrode part 222 can extend in a direction parallel to a direction in which the second electrode part 212 extends.

The third electrode part 221 and the fourth electrode part 222 are connected to each other. For example, the third electrode part 221 and the fourth electrode part 222 are formed integrally.

The fourth electrode part 222 connects a plurality of third electrode parts 221. Accordingly, a plurality of third electrode parts 221 can be connected to an external circuit board by the fourth electrode part 222.

The third electrode part 221 pushes out the light conversion particle 330a. For example, a negative voltage can be applied to the second electrode 220. The third electrode part 221 can push out the light conversion particle 330a by a repulsive force.

The first electrode part 211 and the third electrode part 221 are separated from each other. In detail, the first electrode part 211 and the third electrode part 221 are spaced apart in the second direction 2D. The first electrode part 211 and the third electrode part 221 are spaced apart by a set range. In detail, the first electrode part 211 and the third electrode part 221 are spaced apart by a spacing of 20 μm, 25 μm, or 30 μm or more.

If the first electrode part 211 and the third electrode part 221 are spaced apart by a spacing of less than 20 μm, the first electrode part 211 and the third electrode part 221 may be connected to each other due to an error during the process. This may cause a short circuit.

The first electrode 210 includes the first electrode part 211 and the second electrode part 212. In addition, the second electrode 220 includes the third electrode part 221 and the fourth electrode part 222. That is, the first electrode 210 and the second electrode 220 are each formed as a pattern electrode on one surface of the second substrate 120.

A length direction of the accommodation part 320 extends in the second direction 2D. The accommodation part 320 includes a first overlapping region OA1 and a second overlapping region OA2. The first overlapping region OA1 is a region where the accommodation part 320 and the first electrode part 211 overlap. The second overlapping region OA2 is a region where the accommodation part 300 and the third electrode part 221 overlap.

The first overlapping region OA1 and the second overlapping region OA2 may be alternately disposed.

Voltages having different polarities may be applied to the first electrode 210 and the second electrode 220. For example, a positive voltage may be applied to the first electrode 210. In addition, a negative voltage may be applied to the second electrode 220.

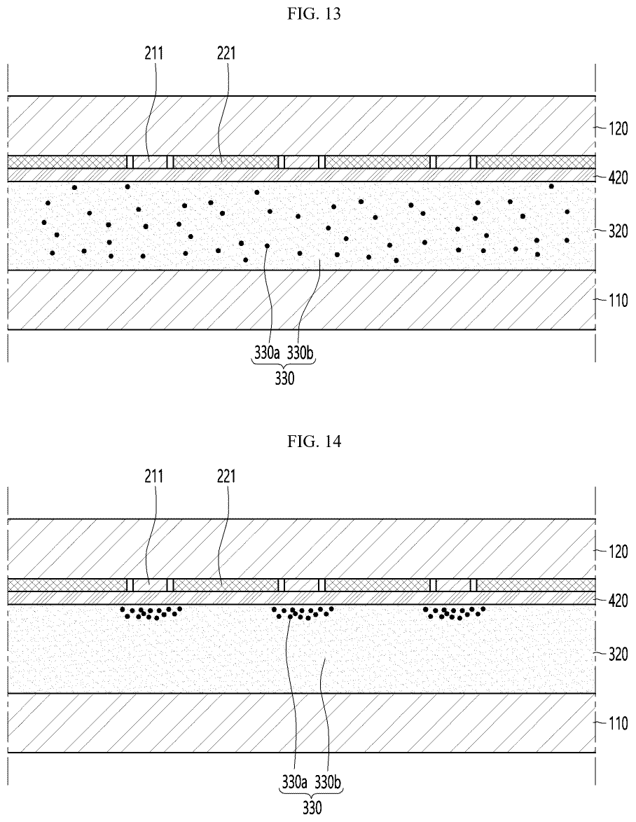

Accordingly, referring to FIGS. 13 and 14, when power is not applied to the optical path control member, the light conversion particle 330a is dispersed inside the accommodation part 320.

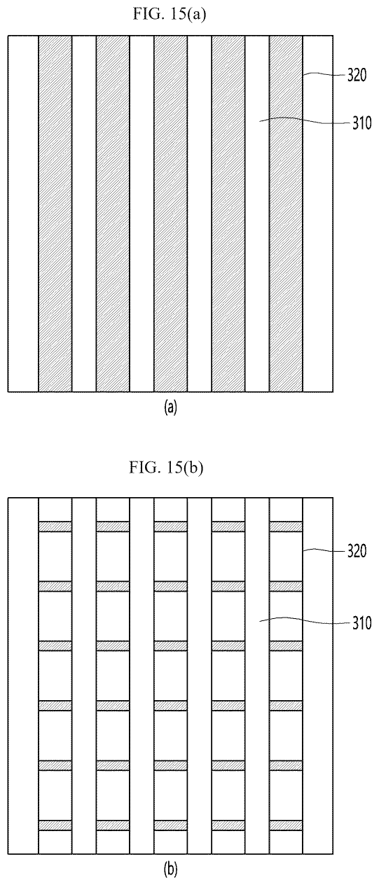

Therefore, as shown in (a) of FIG. 15, light transmission is blocked in the accommodation part 320. Therefore, the optical path control member is driven in a privacy mode.

In addition, when power is applied to the optical path control member, the light conversion particle 330a moves toward the electrode to which the positive voltage is applied. That is, the light conversion particle 330a moves toward the first electrode part 211. That is, the light conversion particle 330a does not move toward the third electrode part 221, but only moves toward the first electrode part 211.

Therefore, light is transmitted through the accommodation part 320 as in (b) of FIG. 15. Therefore, the optical path control member is driven in the public mode.

That is, the light transmittance of the optical path control member can be improved in the public mode. That is, the light conversion particle moves only toward the first electrode part 211 having a width of the range set in the public mode. Therefore, the region where the light conversion particle is aggregated is reduced. Therefore, a light transmitting region of the optical path control member is widened in the public mode. Accordingly, the light transmittance of the optical path control member can be improved.

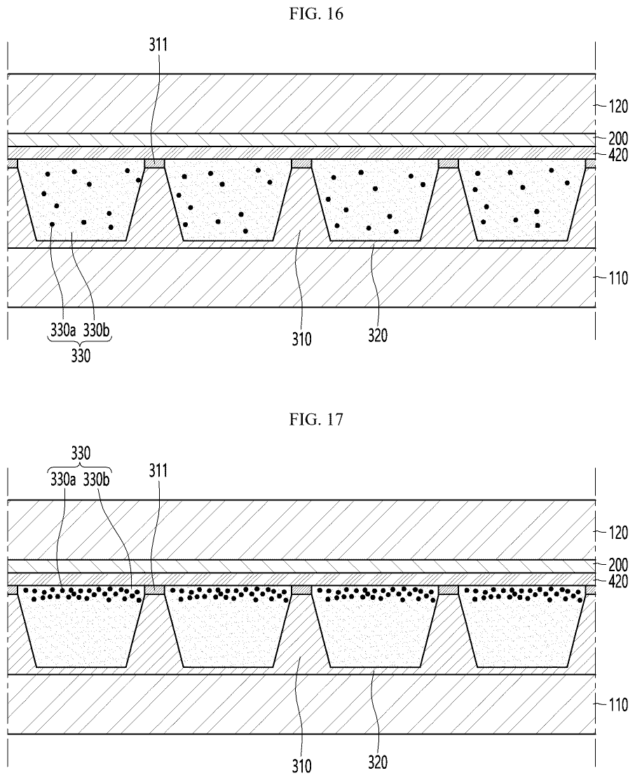

Referring to FIGS. 16 to 18, the partition wall part 310 can include a light-blocking region 311. The light-blocking region 311 may be disposed on an upper portion of the partition wall part 310.

The light-blocking region 311 blocks light. Accordingly, the light transmittance in the privacy mode may be reduced.

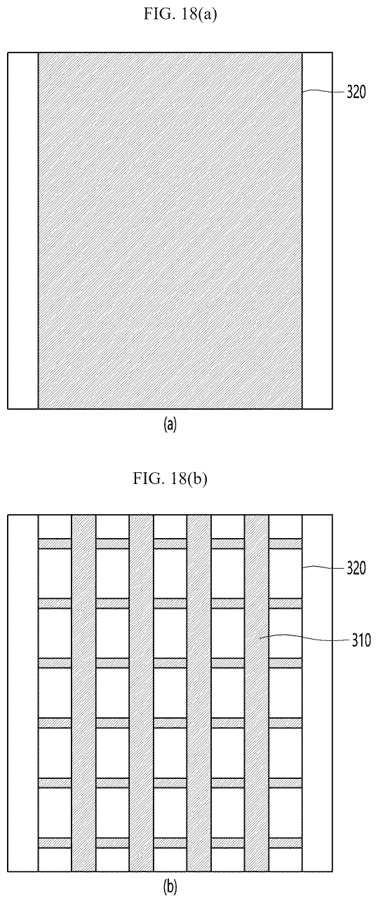

That is, as shown in (a) of FIG. 18, the light-blocking region in the privacy mode may be increased. That is, the light of the accommodation part 320 is blocked by the dispersion of the light conversion particle. In addition, the light of the partition wall part 310 is blocked by the light-blocking region 311.

In addition, as shown in (b) of FIG. 18, a light-transmitting region in the public mode may be changed. That is, since the light of the partition wall part 310 is blocked by the light-blocking region 311, the optical path control member may transmit light in a region of a lattice shape.

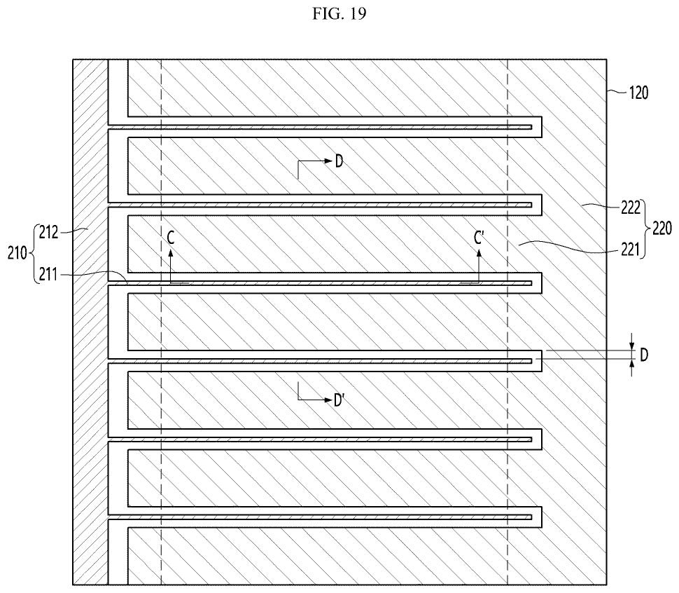

Referring to FIGS. 19 to 23, the optical path control member may omit the partition wall part 310.

Accordingly, the light conversion part 300 may include only the accommodation part 320 and the light conversion material 300 disposed inside the accommodation part 320.

Therefore, the light-blocking region in the privacy mode may be increased. That is, as shown in (a) of FIGS. 20, 22, and 24, light is blocked by the light conversion particle 330a in the privacy mode. That is, since the partition wall part through which light is transmitted is omitted, light in all regions of the light conversion part may be blocked in the privacy mode. Therefore, the light blocking characteristic in the privacy mode may be improved.

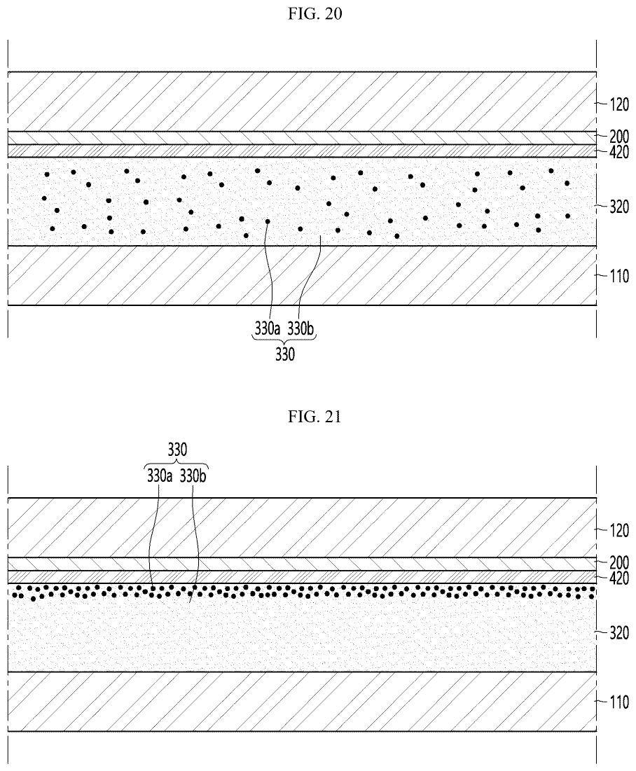

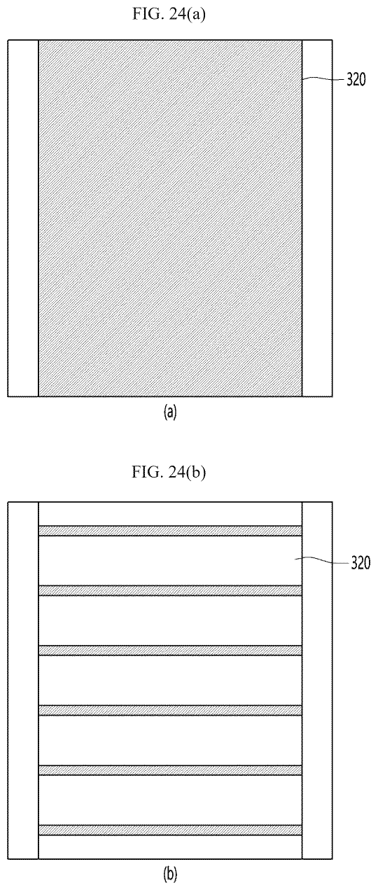

In addition, as shown in (b) of FIGS. 21, 23, and 24, the optical path control member moves in one direction in the public mode, and light is transmitted. Since the light conversion particle 330a moves only in a direction toward the first electrode part 211, light conversion particle can be aggregated in a stripe shape as in (b) of FIG. 24.

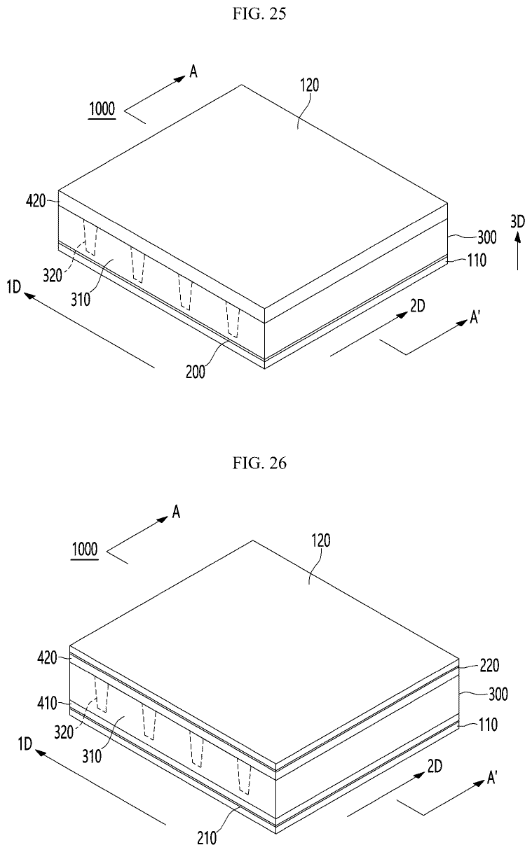

Meanwhile, in the above description, the first electrode 210 and the second electrode 220 are disposed on the second substrate 120. However, the embodiment is not limited thereto. The optical path control member according to the second embodiment can arrange the first electrode 210 and the second electrode 220 on the first substrate 110 as in FIG. 25.

In this case, the positions, sizes, and arrangements of the first electrode 210 and the second electrode 220 on the second substrate 120 described above can be applied identically.

That is, even when the first electrode 210 and the second electrode 220 are disposed on the first substrate 110, the structures of FIGS. 2 to 16 described above can be equally applied.

Hereinafter, another optical path control member according to the second embodiment will be described with reference to FIGS. 26 to 34.

Referring to FIG. 26, the optical path control member can be disposed such that the first electrode 210 and the second electrode 220 are disposed on one surface of the first substrate 110 and one surface of the second substrate 120, respectively.

The first electrode 210 is disposed on one surface of the first substrate 110. In addition, the second electrode 220 is disposed on one surface of the second substrate 120.

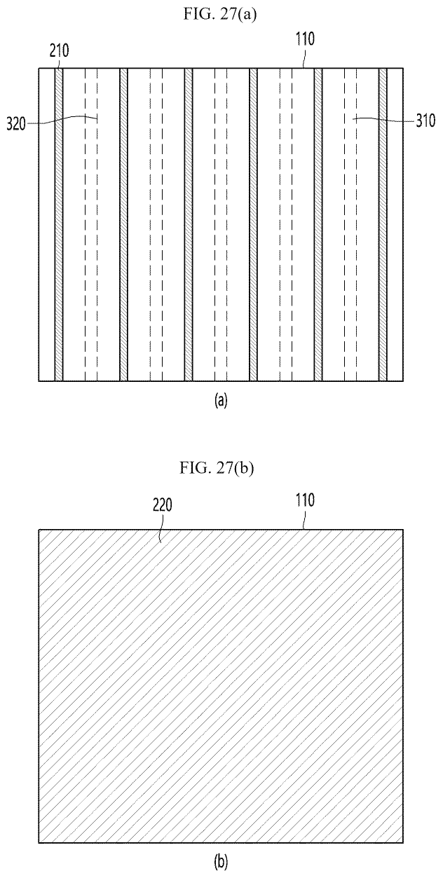

Referring to FIG. 27, the first electrode 210 is disposed in a region corresponding to the accommodation part 320. In detail, the first electrode 210 is disposed in a region corresponding to a part of the accommodation part 320. That is, the first electrode 210 overlaps the accommodation part 320 in the thickness direction of the first substrate 110. The first electrode 210 includes a plurality of electrode parts spaced apart from each other. The first electrode 210 extends in the second direction 2D. That is, the first electrode 210 extends in a direction parallel to a length direction of the accommodation part 320. However, the embodiment is not limited thereto. The first electrode 210 can extend in the first direction 1D. That is, the first electrode 210 can extend in a direction perpendicular to the length direction of the accommodation part 320.

In addition, the second electrode 220 is disposed in a region corresponding to the partition wall part 310 and the accommodation part 320. That is, the second electrode 220 overlaps the partition wall part 310 and the accommodation part 320 in the thickness direction of the second substrate 1210. The second electrode 220 is disposed as a surface electrode. That is, the second electrode 220 can be disposed on an entire surface of one surface of the second substrate 120.

When power is not applied to the optical path control member, the optical path control member operates in a privacy mode.

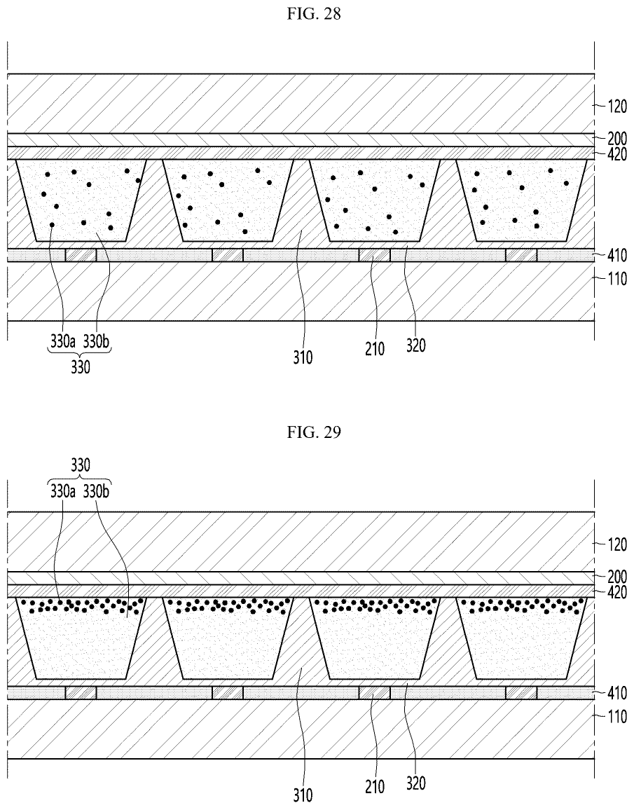

As shown in FIG. 28, when power is not applied to the optical path control member, the light conversion particle 330a is dispersed inside the accommodation part 320. Accordingly, the movement of light is blocked by the accommodation part 320. Accordingly, the optical path control member is driven in privacy mode.

When power is applied to the optical path control member, the optical path control member is driven in privacy mode or public mode.

As shown in FIG. 29, when a negative voltage is applied to the first electrode 210 and a positive voltage is applied to the second electrode 220, the light conversion particle 330a moves toward the second electrode 220 by attraction. Accordingly, the movement of light is blocked by the accommodation part 320. Accordingly, the optical path control member is driven in privacy mode.

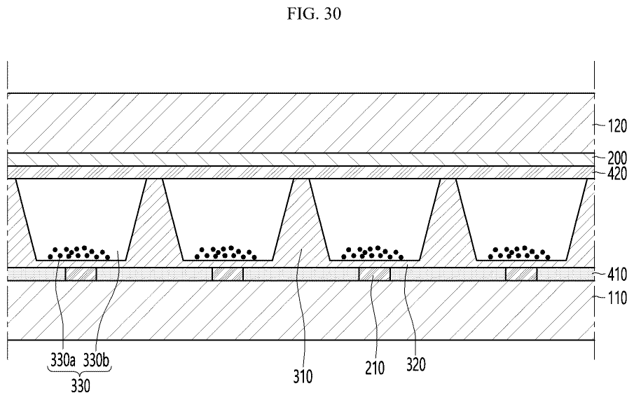

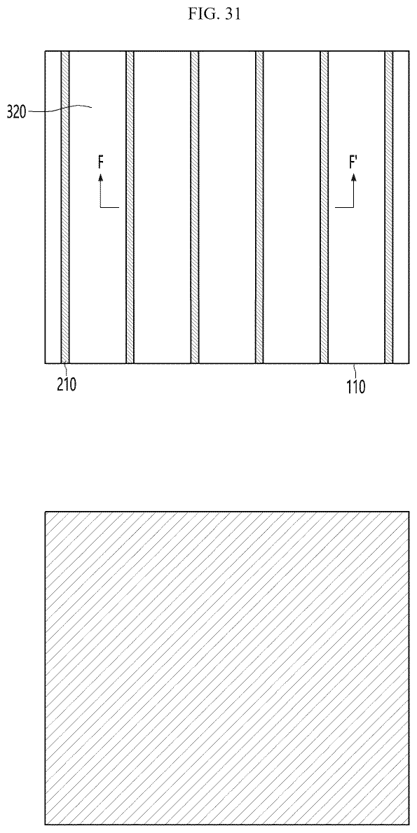

Alternatively, as shown in FIG. 30, when a positive voltage is applied to the first electrode 210 and a negative voltage is applied to the second electrode 220, the light conversion particle 330a moves toward the first electrode 210 by attraction. Accordingly, the light passes through the accommodation part 320. Accordingly, the optical path control member is driven in the public mode.

The light transmittance of the optical path control member can be increased in the public mode. That is, the first electrode 210 is formed by a plurality of pattern electrodes spaced apart from each other. In addition, the light conversion particle can move to a region where the pattern electrodes are disposed.

Accordingly, a region where the light conversion particle is aggregated decreases. Therefore, the light transmittance in the public mode can be increased.

Referring to FIGS. 31 to 34, the partition wall part 310 of the optical path control member can be omitted.

Accordingly, the light conversion part 300 may include only the accommodation part 320 and the light conversion material 300 disposed inside the accommodation part 320.

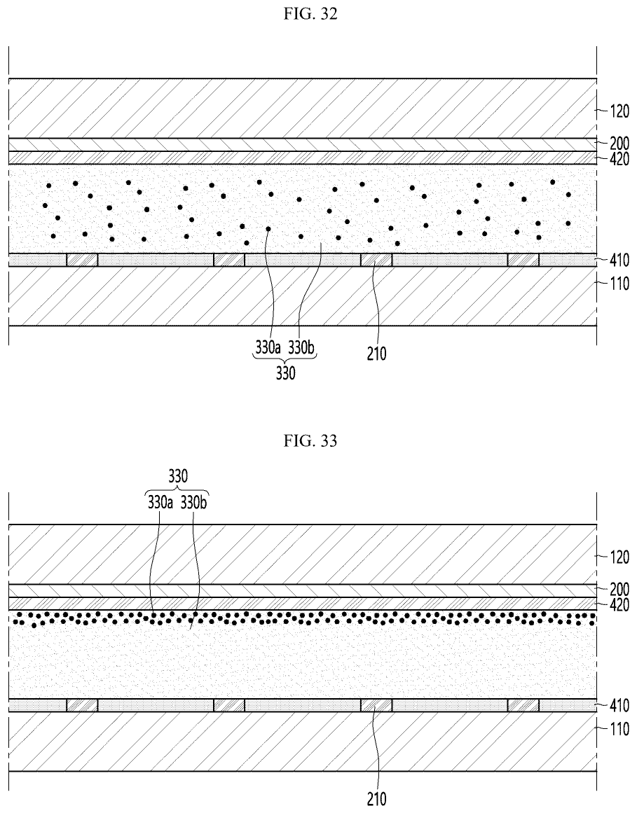

Therefore, the light blocking region in the privacy mode may be increased. That is, referring to FIG. 32 and FIG. 33, in the privacy mode, light is blocked by the light conversion particle 330a disposed inside the accommodation part 320. That is, since the partition wall part through which light is transmitted is omitted, light in all regions of the light conversion part may be blocked in the privacy mode. Therefore, the light blocking characteristic in the privacy mode may be improved.

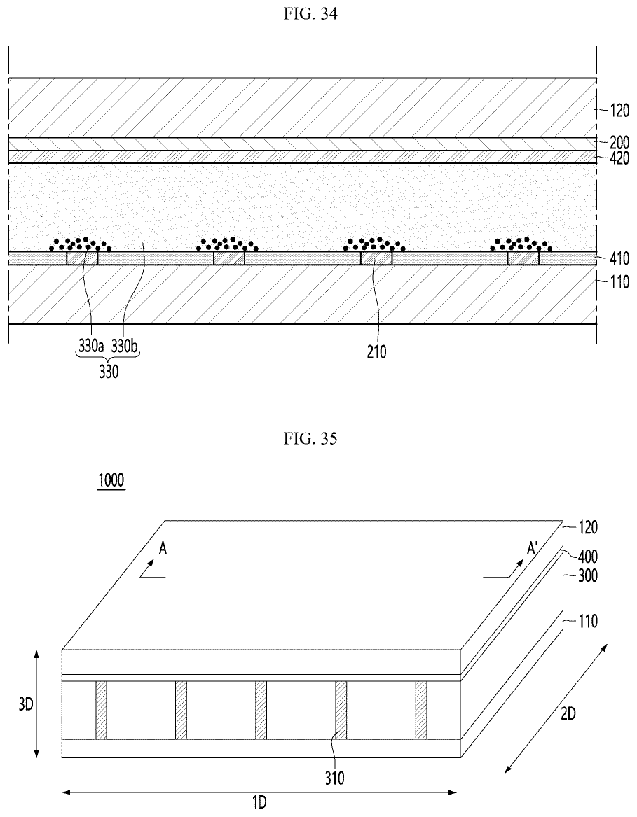

In addition, as shown in FIG. 34, in the public mode, the light conversion particle 330a moves in one direction and light is transmitted. Since the light conversion particle 330a moves only in a direction toward the first electrode 210, the light conversion particle 330a may be aggregated in a stripe shape like the pattern electrode shape of the first electrode 210.

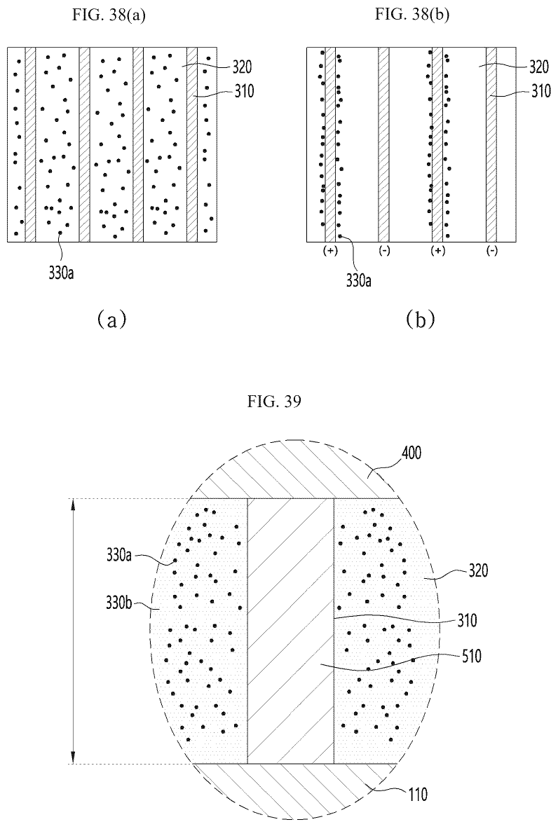

Hereinafter, an optical path control member according to a third embodiment will be described with reference to FIGS. 35 to 48. A same description as that of the first embodiment is omitted in a description of the third embodiment. Also, a same drawing reference numerals are given to a same configuration as the first embodiment. The first embodiment and the third embodiment may be combined. Alternatively, the first embodiment and the third embodiment may be independent.

Referring to FIGS. 35 to 48, an optical path control member 1000 according to the third embodiment includes a first substrate 110, a second substrate 120, and a light conversion part 300.

The partition wall part 310 includes an opaque material. The partition wall part 310 includes a material that does not transmit light. For example, the partition wall part 310 includes a metal. A voltage is applied to the partition wall part 310. In detail, a positive voltage and a negative voltage are applied to the partition wall part 310.

When power is not supplied from an outside, the partition wall part 310 divides the accommodation part 320 into a plurality of accommodation parts. In addition, when power is supplied from the outside, the partition wall part 310 becomes an electrode. That is, at least one partition wall part among the plurality of partition wall parts is driven by a negative electrode, and at least one other partition wall part is driven by a positive electrode.

Accordingly, when power is supplied to the optical path control member, the light conversion particle 330a disposed inside the accommodation part 320 moves toward the partition wall part 310.

The partition wall part 310 may include partition wall parts having different sizes. In detail, a width of the partition wall part driven by a negative electrode and a width of the partition wall part driven by a positive electrode among the partition wall parts may be different. For example, the width of the partition wall part driven by a positive electrode may be larger than the width of the partition wall part driven by a negative electrode.

Accordingly, the conductivity of the partition wall part driven by the positive electrode is improved. Accordingly, the light conversion particle can move quickly in the direction of the partition wall part in the public mode. Accordingly, the driving characteristics of the optical path control member can be improved.

In addition, the width of the partition wall part driven by the negative electrode is reduced. Accordingly, the light transmitting region in the public mode can increase. Accordingly, the transmission characteristics of the optical path control member can be improved.

Accordingly, electrodes disposed on upper and lower portions of the first substrate and the second substrate can be omitted. In addition, a buffer layer for bonding the electrodes can be omitted.

Accordingly, the optical path control member according to the third embodiment can be formed with a slim thickness. In addition, since some layer structures are omitted, a manufacturing process becomes easy.

Hereinafter, the partition wall part will be described in detail with reference to the drawings.

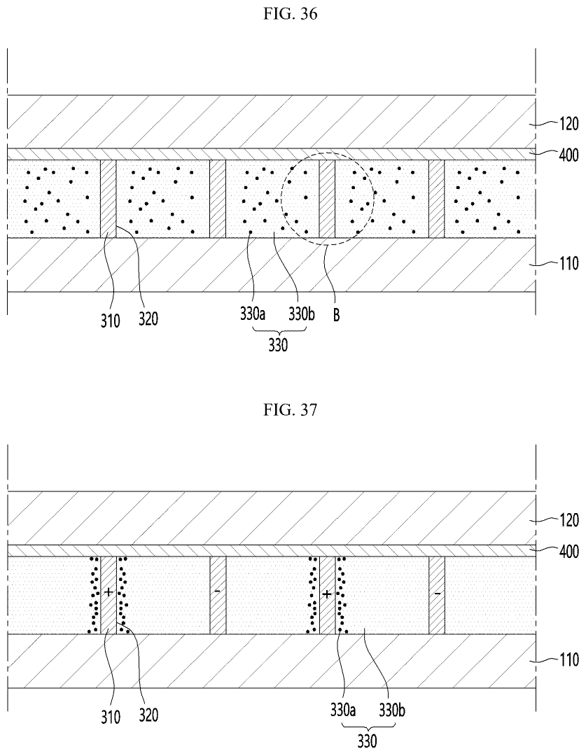

FIGS. 39 to 46 are enlarged views of region B of FIG. 36.

Referring to FIGS. 39 to 41, the partition wall part 310 includes a metal. The partition wall part 310 may include chromium (Cr), nickel (Ni), copper (Cu), aluminum (Al), silver (Ag), molybdenum (Mo), gold (Au), titanium (Ti), or an alloy thereof.

The partition wall part 310 may include one or more layers. In detail, the partition wall part 310 may include one or more metal layers.

For example, referring to FIG. 39, the partition wall part 310 may include one metal. For example, the partition wall part 310 may include only the first metal layer 510.

The partition wall part 310 may be formed by plating or deposition. First, a seed layer is formed on the first substrate 110. For example, the seed layer may include copper. The seed layer may be formed by a deposition or electroless plating process.

Subsequently, a plating layer is formed using the seed layer. For example, the partition wall part 310 may be formed by an electrolytic plating process using the seed layer. Accordingly, the partition wall part 310 may be formed by a first metal layer 510 including copper (Cu).

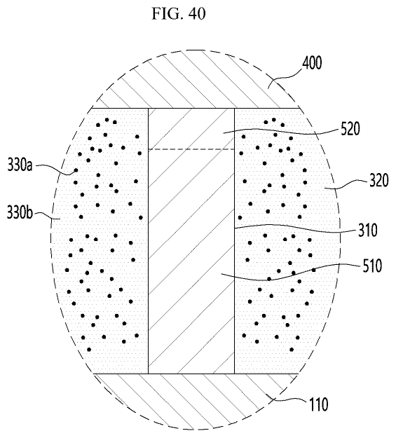

Alternatively, referring to FIG. 40, the partition wall part 310 may include a plurality of metals. For example, the partition wall part 310 may include a first metal layer 510 and a second metal layer 520 disposed on the first metal layer 510.

For example, the partition wall part 310 may be formed by plating or deposition. First, a seed layer is formed on the first substrate 110. For example, the seed layer may include copper. The seed layer may be formed by a deposition or electroless plating process.

Then, the first metal layer 510 is formed using the seed layer. For example, the first metal layer 510 is formed by an electrolytic plating process using the seed layer.

Then, the second metal layer 520 is formed on the first metal layer 510. For example, a second metal may be deposited on the first metal layer 510 to form the second metal layer 520. The first metal and the second metal may include different metals.

Accordingly, the partition wall part 310 may include a first metal layer 510 and a second metal layer 520 including different metals.

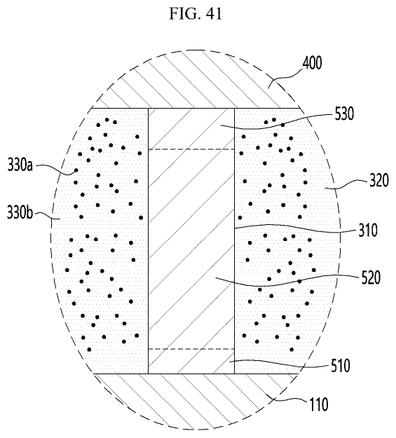

Alternatively, referring to FIG. 41, the partition wall part 310 may include a plurality of metals. For example, the partition wall part 310 may include a first metal layer 510, a second metal layer 520 disposed on the first metal layer 510, and a third metal layer 530 disposed on the second metal layer 520.

First, a first metal may be deposited on the first substrate 110 to form the first metal layer 510.

Subsequently, the second metal layer 520 may be formed on the first metal layer 520. For example, a second metal may be deposited on the first metal layer 510 to form the second metal layer 520.

Subsequently, a third metal layer 530 may be formed on the second metal layer 520. For example, a third metal may be deposited on the second metal layer 520 to form the third metal layer 530.

At least one of the first metal, the second metal, and the third metal may include a material different from other metals.

Accordingly, the partition wall part 310 may include a first metal layer 510, a second metal layer 520, and a third metal layer 530 including different metals.

For example, the first metal and the third metal may include a metal different from the second metal. In addition, the first metal and the third metal may include a same metal or different metals.

A thickness T of the partition wall part 310 may be formed within a set range. In detail, the thickness T of the partition wall part 310 may be 10 μm or more. In more detail, the thickness T of the partition wall part 310 may be 15 μm to 30 μm. In more detail, the thickness T of the partition wall part 310 may be 17 μm to 25 μm.

If the thickness T of the partition wall part 310 is less than 15 μm, the thickness of the accommodation part 320 also decreases. Accordingly, the light conversion material is not disposed at a sufficient height. Accordingly, the light blocking characteristic of the optical path control member may decrease. In addition, if the thickness T of the partition wall part 310 exceeds 30 μm, the thickness of the accommodation part 320 also increases. Accordingly, a driving voltage of the optical path control member may increase due to the increase in the height of the light conversion material.

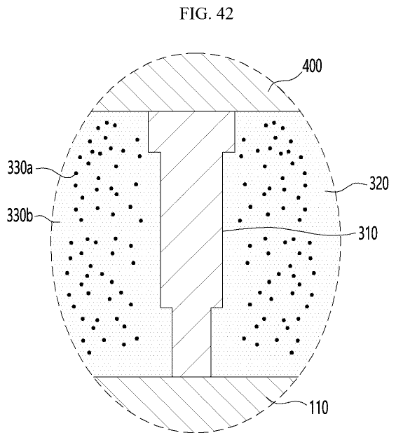

Referring to FIG. 42, a width of the partition wall part 310 may vary depending on a location. In detail, the width of the partition wall part 310 may include a region that narrows while extending from the first substrate 110 toward the second substrate 120.

The change in the width of the partition wall part 310 occurs due to a process of forming the partition wall part 310. That is, when forming the partition wall part 310, an etching process of the seed layer is performed. As a result, the partition wall part 310 is divided into a plurality of partition wall parts. At this time, the degree to which the layers of the partition wall part are etched may vary depending on an etching solution. Accordingly, the width of the partition wall part 310 may include a region that narrows while extending from the first substrate 110 toward the second substrate 120.

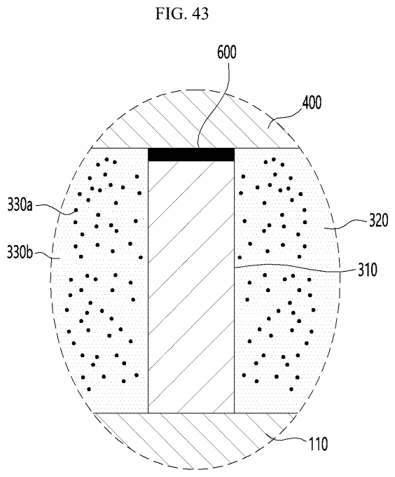

Referring to FIGS. 43 to 46, the partition wall part 310 may include an insulating layer 600. The insulating layer 600 may be an oxide layer. The insulating layer 600 may be an antireflection layer. The insulating layer 600 may be a blackening layer. The insulating layer 600 may be a low-reflection layer. The insulating layer 600 may be a high-roughness layer. The insulating layer 600 may be disposed on at least one of an upper surface, a lower surface, and a side surface of the partition wall part 310.

Referring to FIG. 43, the insulating layer 600 may be disposed on the upper surface of the partition wall part 310. The insulating layer 600 may be formed integrally with the metal layer of the partition wall part 310. That is, the insulating layer 600 may be formed by oxidizing a portion of a metal layer of the partition wall part 310.

The insulating layer 600 may be formed in black. Accordingly, the light-blocking characteristic may be improved in the privacy mode of the optical path control member.

A reflectivity of the insulating layer 600 and a reflectivity of the metal layer may be different. In detail, the reflectivity of the insulating layer 600 may be smaller than the reflectivity of the metal layer. For example, the reflectivity of the insulating layer 600 may be 70% or less of the reflectivity of the metal layer.

Accordingly, when light is emitted from the first substrate 110 toward the second substrate 120, the amount of light reflected from the upper portion of the partition wall part 310 may be reduced. Accordingly, the user's visibility may be improved.

A surface roughness of the insulating layer 600 and a surface roughness of the metal layer may be different. In detail, the surface roughness of the insulating layer 600 may be larger than the surface roughness of the metal layer.

Accordingly, an adhesive strength between the partition wall part 310 and the adhesive layer 400 may be increased. That is, since the surface roughness of the insulating layer 600 increases, an contact area between the insulating layer 600 and the adhesive layer 400 can increase. Accordingly, the adhesive strength of the insulating layer 600 and the adhesive layer 400 can increase. Accordingly, the adhesive strength of the partition wall part 310 and the second substrate 120 can be improved.

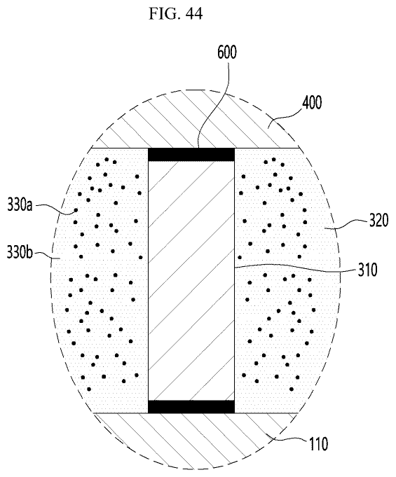

Referring to FIG. 44, the insulating layer 600 can be disposed on the upper and lower portions of the partition wall part 310.

Since the insulating layer 600 is also disposed on the lower portion of the partition wall part 310, the light transmittance of the optical path control member can be improved. That is, when light moves from the first substrate 110 toward the second substrate 120, the amount of light reflected from the lower portion of the partition wall part 310 can be reduced. Accordingly, the light transmittance in the public mode can be improved.

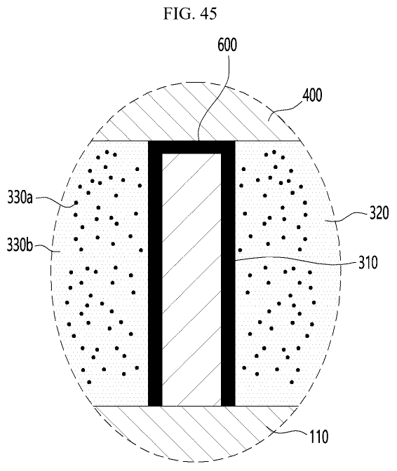

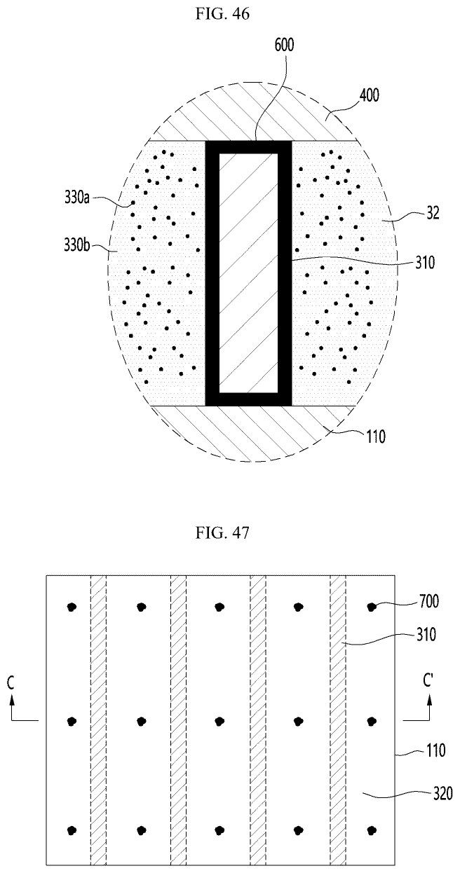

Referring to FIGS. 45 and 46, the insulating layer 600 may also be disposed on a side portion of the partition wall part 310. For example, referring to FIG. 45, the insulating layer 600 may be disposed on an upper portion and a side portion of the partition wall part 310. Alternatively, referring to FIG. 46, the insulating layer 600 may be disposed on the upper, lower, and side portions of the partition wall part 310. That is, the insulating layer 600 may surround the partition wall part 310.

Since the insulating layer 600 is also disposed on the side of the partition wall part 310, the light transmittance of the optical path control member may be improved. That is, when light moves from the first substrate 110 toward the second substrate 120, the decrease in light transmittance due to scattering of light reflected from the side portion of the partition wall part 310 may be prevented. Accordingly, a brightness of the optical path control member can be improved.

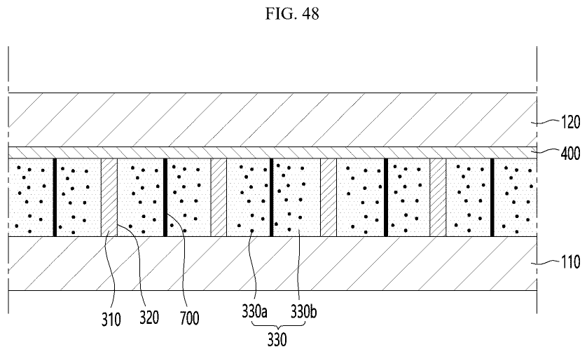

Referring to FIGS. 47 and 48, the optical path control member may include a dummy pattern 700.

In detail, a plurality of dummy patterns 700 are disposed on the first substrate 110. The dummy patterns 700 are disposed in a region corresponding to the accommodation part 320. That is, the dummy patterns 700 are disposed inside the accommodation part 320.

The dummy patterns 700 extend from the first substrate 110 toward the adhesive layer 400. Accordingly, one end of the dummy pattern 700 contacts the first substrate 110. In addition, other end of the dummy pattern 700 contacts the adhesive layer 400.

The dummy patterns 700 may include a non-conductive material. Accordingly, when the light conversion particle moves in the public mode, the dummy pattern 700 can be prevented from interfering.

In addition, the dummy pattern 700 can include a transparent material. Accordingly, when operating in the public mode, the light transmittance can be prevented from being reduced by the dummy pattern 700.

The dummy pattern 700 can prevent the phenomenon of the adhesive layer 400 and the second substrate 120 sinking toward the first substrate 110. That is, the adhesive layer 400 comes into contact only with the partition wall part 310 having a width smaller than that of the accommodation part 320. Accordingly, the second substrate 120 and the adhesive layer 400 can sink toward the first substrate 110 by the accommodation part 320. Accordingly, a plurality of dummy patterns 700 are disposed in a region of the accommodation part 320. The dummy pattern can support the adhesive layer 400 and the second substrate 120.

Therefore, the phenomenon of the adhesive layer 400 and the second substrate 120 sinking in one direction can be prevented, thereby preventing the shape deformation of the optical path control member.

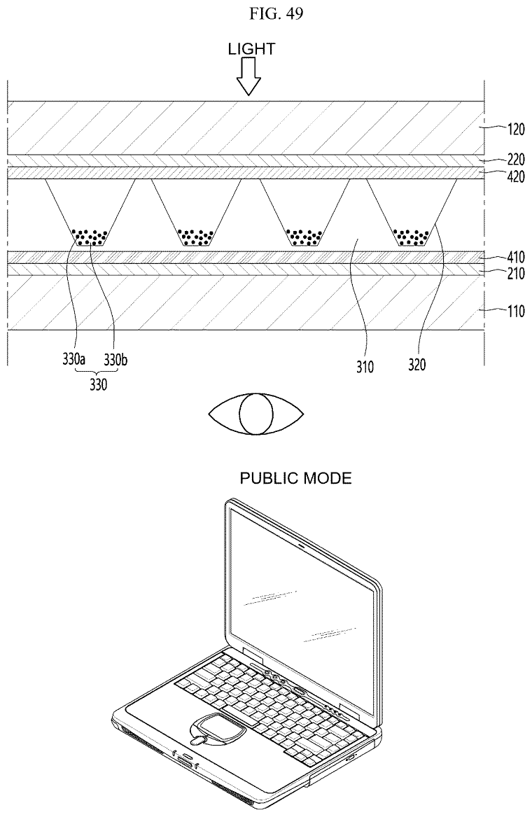

Referring to FIGS. 49 to 53, the optical path control member according to the embodiments can be applied to various display devices.

Referring to FIGS. 49 and 450, the optical path control member can be applied to the display device.

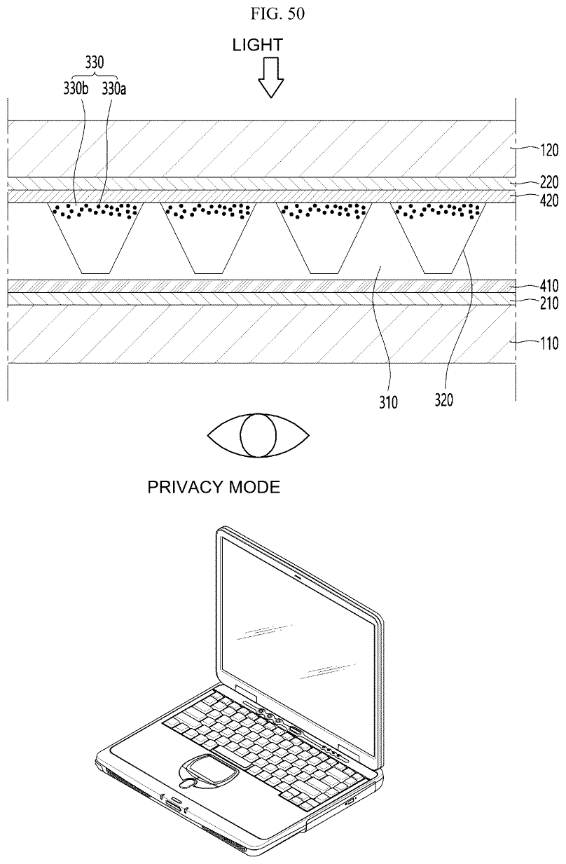

For example, when the optical path control member is driven in a public mode as in FIG. 49, the display device is driven in the public mode. In addition, when the optical path control member is driven in the privacy mode as in FIG. 50, the display device is driven in the privacy mode.

Accordingly, the user can drive the display device in the public mode or the privacy mode depending on an application of power.

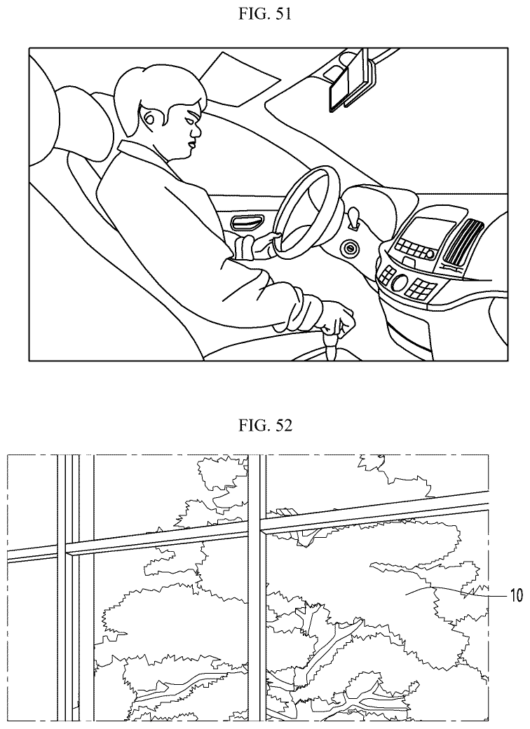

In addition, referring to FIGS. 51 to 53, the display device can be applied to an interior and exterior of a vehicle and windows of a building.

For example, as shown in FIG. 51, the display device can display information about the vehicle or an image for confirming the vehicle's movement path. The display device can be placed between the driver's seat and the passenger seat of the vehicle.

In addition, the optical path control member according to the embodiment can be applied to a dashboard that displays the vehicle's speed, engine, and warning signals.

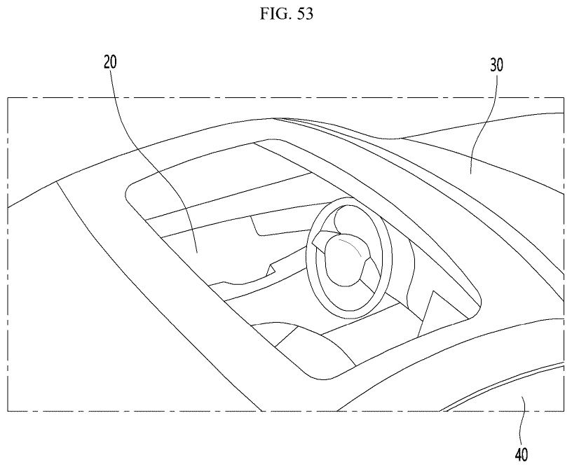

In addition, as shown in FIG. 52, the optical path control member can be applied to a window 10 of a building. Accordingly, the amount of light passing through the window 10 can be controlled.

In addition, as shown in FIG. 53, the optical path control member can be applied to a sunroof 20, a windshield 30, or left and right windows 40 of the vehicle.

The characteristics, structures, effects, and the like described in the above-described embodiments are included in at least one embodiment of the present invention, but are not limited to only one embodiment. Furthermore, the characteristic, structure, and effect illustrated in each embodiment may be combined or modified for other embodiments by a person skilled in the art. Accordingly, it is to be understood that such combination and modification are included in the scope of the present invention.

In addition, embodiments are mostly described above, but the embodiments are merely examples and do not limit the present invention, and a person skilled in the art may appreciate that several variations and applications not presented above may be made without departing from the essential characteristic of embodiments. For example, each component specifically represented in the embodiments may be varied. In addition, it should be construed that differences related to such a variation and such an application are included in the scope of the present invention defined in the following claims.

1. An optical path control member comprising:
a first substrate;
a light conversion part disposed on the first substrate; and
a second substrate disposed on the light conversion part,
wherein the light conversion part includes a plurality of accommodation parts and a plurality of partition wall parts that are disposed alternately,
wherein a light conversion material is disposed inside the accommodation part, and the light conversion material includes a dispersion liquid and light conversion particles dispersed in the dispersion liquid, and
wherein the partition wall parts include a metal material.

2. The optical path control member of claim 12, wherein a ratio of the first width to the second width (first width: second width) is 9:1 or more.

3. The optical path control member of claim 12, wherein the fourth width is smaller than the second width.

4. The optical path control member of claim 12, wherein a vertical cross section of the accommodation part bas a triangular shape.

5. The optical path control member of claim 12, wherein the fourth width is greater than 0 and less than or equal to 1 μm.

6. The optical path control member of claim 12, wherein the second width is 1 μm to 2 μm or less.

7. The optical path control member of claim 1, wherein at least one of the plurality of partition wall parts is driven as a negative electrode according to an application of power.

8. The optical path control member of claim 7, wherein at least an other one of the plurality of partition wall parts is driven as a positive electrode according to an application of power.

9. A display device comprising:
a panel including at least one of a display panel and a touch panel; and
an optical path control member of claim 1 disposed on or under the panel.

10. (canceled)

11. The optical path control member of claim 1, wherein a width of each partition wall part of the plurality of partition wall parts is smaller than a width of each accommodation part of the plurality of accommodation parts, respectively.

12. The optical path control member of claim 1, wherein each partition wall part of the plurality of partition wall parts has a first width defined as a long width of the partition wall part and a second width defined as a short width of the partition wall part,
wherein each accommodation part of the plurality of accommodation parts has a third width defined as a long width of the accommodation part and a fourth width defined as a short width of the accommodation part, and
wherein the third width is greater than the second width.

13. The optical path control member of claim 8, wherein a width of the partition wall part of the negative electrode and a width of the partition wall part of the positive electrode are different.

14. The optical path control member of claim 13, wherein the width of the partition wall part of the positive electrode is larger than the width of the partition wall part of the negative electrode.

15. The optical path control member of claim 13, wherein when the power is applied, the light conversion particles move in a direction toward the partition wall part driven as the positive electrode.

16. The optical path control member of claim 13, wherein the plurality of partition wall parts include at least one metal layer.

17. The optical path control member of claim 13, wherein a thickness of each partition wall part of the plurality of partition wall parts is 10 μm to 30 μm.

18. The optical path control member of claim 13, comprising:
an insulating layer disposed on at least one of upper, lower, and side portions of each partition wall part of the plurality of partition wall parts.

19. The optical path control member of claim 13, wherein the partition wall part includes a region in which width narrows from the first substrate toward the second substrate.

20. The optical path control member of claim 13, comprising:
a dummy pattern disposed inside the accommodation part.

21. The optical path control member of claim 20, comprising:
an adhesive layer between the light conversion part and the second substrate,
wherein one end of the dummy pattern contacts the first substrate, and
wherein other end of the dummy pattern contacts the adhesive layer.
